(19) United States
(12) Patent Application Publication
(10) Pub. No.: US 2026/0128964 A1
(43) Pub. Date: May 7, 2026

(54) TRAFFIC GEOLOCATION DETERMINING WITHIN SECTIONS OF AREA OF INTEREST

(71) Applicant: DISH Wireless L.L.C., Englewood, CO (US)

(72) Inventors: Yifei Zhao, Denver, CO (US); Ahmed Awwad Whdan, Centennial, CO (US)

(21) Appl. No.: 18/939,199

(22) Filed: Nov. 6, 2024

(51) Int. Cl. H04L 41/22; H04L 41/147; H04L 43/0882

(52) U.S. Cl. CPC H04L 41/22; H04L 41/147; H04L 43/0882

(57) ABSTRACT

A method includes presenting, within a display device of a computing system, a graphical user interface (GUI) including a map of an area of interest (AOI) of the cellular network and partitioning at least a sub-area of the AOI into a plurality sections, wherein each section is formed from a particular pixel area of the GUI. The method includes retrieving a plurality of geolocations, within each section of the plurality of sections, of subscriber devices based on known geolocations. The method includes determining, using call record detail (CDR) data, a capacity metric volume for each sector of a plurality of sites covering the AOI and the capacity metric volume for each section based on the plurality of geolocations and the capacity metric volume of each sector.

### BACKGROUND

Telecommunication networks, such as cellular networks, have various resources that produce data and metadata concerning operations of the cellular network. Metadata is data that provides information about data. Metadata enriches the data with information about one or more aspects of the data. Metadata insights can facilitate efficient processing and understanding the data. Status reports, including error codes, may be generated which are indicative of deficiencies in operations of the network, including deficiencies in network capacity and connectivity.

With the development of communication technologies, such as fifth generation (5G) new radio (NR) cellular networks, applications supporting a massive number of connected devices are enabled. Such applications can be based on data from myriad sources, including third party sources. Also, as the number of connected devices grows, ensuring that network capacity commensurately grows can be challenging, particularly in meeting increasing cellular traffic demands for that network capacity. Typically, engineers manually analyze alerts, errors, broken connections, and other capacity deficiencies to determine where design changes are necessary in the cellular network. This means that design changes to address capacity deficiencies are generally insufficient, overly costly, and/or untimely.

### BRIEF DESCRIPTION OF DRAWINGS

The present disclosure is illustrated by way of example, and not by way of limitation, in the figures of the accompanying drawings.

FIG. 1A is a block diagram of a cellular network system including a computing system in or associated with the cellular network for purposes of capacity planning according to at least one embodiment.

FIG. 1B is a block diagram of the computing system of FIG. 1A according to some embodiments.

FIG. 2A, FIG. 2B, FIG. 2C, FIG. 2D illustrate a graphical user interface (GUI), including a map of an area of interest (AOI) of the cellular network, presentable on a display device of the computing system according to at least some embodiments.

FIG. 3 is an image of a menu presentable within the GUI as an overlay to the map and that provides selection options of various capacity-related aspects of the cellular network according to some embodiments.

FIG. 4 is a screen capture of a GUI in which a map is presented having illustrated a plurality of partitioned sections of the AOI according to exemplary embodiments.

FIG. 5 is a an image of a representative group of sections of the plurality of partitioned sections of FIG. 4, illustrating an example of determining a traffic metric volume for individual sections according to some embodiments.

FIG. 6 is an image of a representative group of sections of the plurality of sections of FIG. 4, illustrating how known samples of geolocations of subscriber devices are distributed based on sector and cell according to some embodiments.

FIG. 7 is a flow chart of a method for determining a capacity metric volume for each section based on a plurality of known geolocations and capacity metric volume of each cell according to some embodiments.

FIG. 8A is a flow chart of an example method for partitioning the AOI according to at least one embodiment.

FIG. 8B is a flow chart of an example method for predicting additional geolocations within each section based on call record detail (CDR) data according to some embodiments.

FIG. 9 is a flow chart of an example method of determining capacity metric volume from each cell in order to determine a capacity metric volume for each section according to some embodiments.

FIG. 10A is a screen capture of the map in which different sections are shaded differently based on a particular volume range of a capacity metric in each respective section according to an exemplary embodiment.

FIG. 10B is a zoomed-in area of some of the different sections of the map of FIG. 10A to illustrate the shading with more clarity according to some embodiments.

FIG. 11 illustrates a block diagram illustrating an exemplary computer device (or computing device), in accordance with implementations of the present disclosure.

### DETAILED DESCRIPTION

As discussed above, as communication technologies advance, including the emergence of 5G new radio cellular networks, the number of connected devices grows, ensuring that cellular network capacity commensurately grows can be challenging, particularly in meeting increasing cellular traffic demands for that network capacity. Typically, engineers manually analyze alerts, errors, broken connections, and other capacity deficiencies to determine where design changes are necessary. It is not straight forward to associate capacity deficiencies with particular sites or sectors of a cellular network, even with access to subscriber data, due to not being able to geolocate subscriber devices throughout an area of interest (AOI). This can mean that design changes to address capacity deficiencies are generally insufficient, overly costly, and/or untimely. Also, without the ability to visually see interactions of sites within the cellular network, design changes are made more complicated and less intuitive.

Aspects and embodiments of the present disclosure overcome these deficiencies and others by implementing a compute-driven capacity planning tool that presents, within a display device, based on geolocation data, a graphical user interface (GUI) having a map with graphical objects representing components (or elements) of cellular sites of a cellular network throughout a selectable AOI. A computing system implementing such a capacity planning tool can further partition at least a sub-area of the AOI into a plurality sections, each section being formed from a particular pixel area of the GUI (e.g., a particular length and width of pixels). The computing system can retrieve a plurality of geolocations, within each section of the plurality of sections, of subscriber devices based on known geolocations, e.g., from geolocating applications running on those subscriber devices. The computing system can then determine, using call record detail (CDR) data, a capacity metric volume for each cell of a plurality of sites covering the AOI and determine the capacity metric volume for each section based on the plurality of geolocations and the capacity metric volume of each cell.

In differing embodiments, the capacity metric volume corresponds to a capacity metric such as radio resource control (RRC) connections (e.g., number of UEs to connect to a particular network component), traffic volume, or unserved demand bandwidth (e.g., amount of streaming data that was deficient to fulfill streaming demands), among others. In this way, by determining the capacity metric volume for each section that the computing system partitioned within the AOI, the computing system can determine whether a particular deficiency exists (such as overly high number of RRC connections or traffic volume), which can trigger adding resources such as new cells or sectors or shifting traffic from over-taxed sectors to less-busy sectors. Examples of such solutions to capacity deficiencies are discussed in detail in U.S. application Ser. No. 18/911,614, filed Oct. 10, 2024, entitled “Capacity Solutions in Capacity Planning Graphical User Interface for Cellular Network,” which is incorporated herein by this reference.

Particular implementations of the subject matter described in this disclosure can be implemented so as to realize one or more of the following advantages. For example, the disclosed compute-driven capacity planning tool facilities capacity planning at different levels and in different AOIs of a cellular network by first determining capacity metric volume (such as a traffic or RRC connection volume) in the various sections (e.g., discrete smaller portions) of an AOI. Knowing capacity metric volume at such a granular level can help network owners and operators to identify gaps or deficiencies in capacity volume or to identify soon-to-experience gaps or deficiencies in capacity volume to be able to develop solutions that fill those gaps or resolve those deficiencies. In this way, by so employing the capacity planning tool, the network operators can avoid losing connectivity between sites and/or between components of sites within the cellular network, thus ensuring continued quality of service to users. Additional advantages involve the prediction into the future of possible capacity issues that can be addressed with planned design changes, simulation of those planned design changes to test their sufficiency, and projection of costs for such design changes. In quickly growing cellular network environment, these advantages enable network engineers to efficiently keep pace to strategically grow impacted sites and areas of an AOI, project costs, and prevent over spending during such growth.

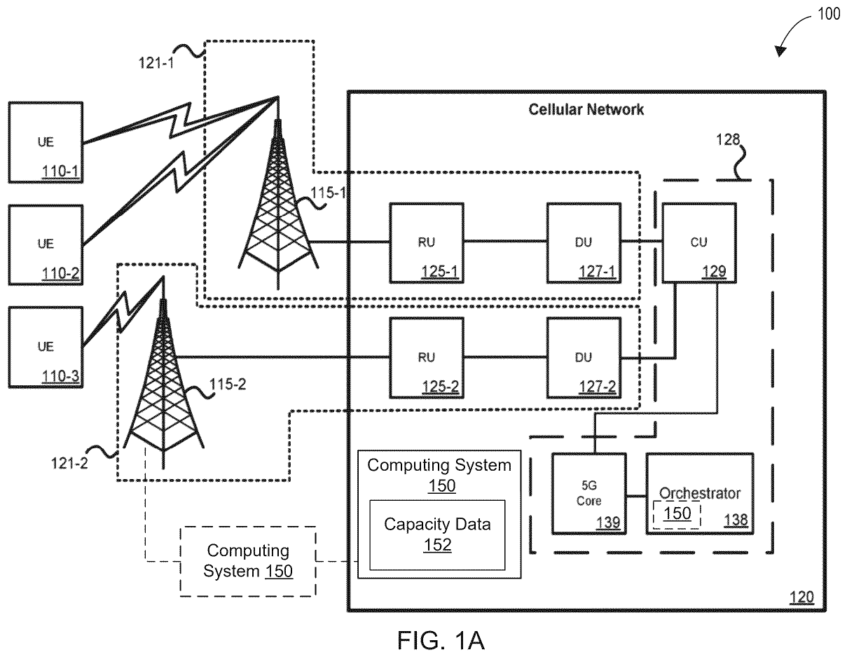

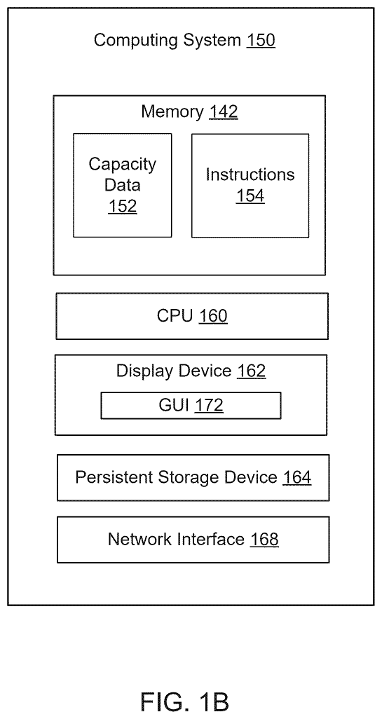

FIG. 1A is a block diagram of a cellular network system 100 including a computing system 150 in or associated with the cellular network for purposes of capacity planning according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. may also be possible. System 100 can include: user equipment (UEs) 110 (e.g., UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), and other computerized devices capable of communicating via a cellular network, etc. Generally, UE 110 can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Each structure 115 can include one or more antennas that allow RUs 125 to communicate wirelessly with UEs 110. RUs 125 can each represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1 and DU 127-2, may communicate with CU 129. Collectively, an RU, DU, and CU create a gNodeB, which serves as the radio access network (RAN) of cellular network 120. CU 129 can communicate with the 5G core 139. The specific architecture of the cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120, which will be expanded on in subsequent Figures. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so it may be desired to avoid allocation of an excess of resources to a particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing can be performed.

The 5G core 139, which can be physically distributed across data centers or located at a central national data center (NDC), can perform various core functions of the cellular network. The 5G core 139 can include: network resource management components; policy management components; subscriber management components; and packet control components. Individual components may communicate on a bus, thus allowing various components of 5G core 139 to communicate with each other directly. The 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1A, the system 100 includes a computing system 150 or data platform. The computing system 150 can be distrusted in some embodiments and include a suite of tools and technologies designed to manage, store, process, analyze, and/or visualize large volumes of data. In varying embodiments, the computing system 150 is located in or implemented as part of the orchestrator 138, is located within the cellular network 120 but outside of the main cellular network components 128, or is located outside of the cellular network 120 but is capable of monitoring data such as capacity information by connecting to the cellular network 120 in similar ways that does a UE.

In at least one embodiment, the computing system 150 is a distributed set of processing devices located in one or more of these three locations that can share one or more memory or storage devices that are capable of storing capacity data 152 (see FIG. 1B). In embodiments, the capacity data 152 is associated with bandwidth of various network components (taken alone and in the aggregate in some cases), call record detail (CDR) data, throughput, network traffic and associated demands for the bandwidth. The computing system 150 can aggregate and track such capacity data 152 for purposes of determining and updating capacity metrics at various layers of the cellular network 120 that informs whether particular network components have (or will have at some point in the future) capacity-related issues that are expected to result in breaks (e.g., dropped calls or dropped network sessions) and the like that result in negative QoS and QoE.

In some embodiments, the computing system 150 is used by modern data-driven organizations, enabling them to harness the power of their data for various purposes, such as business intelligence, analytics, machine learning, and more. In general, the computing system 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The computing system 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring.

Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches.

The computing system 150 can consolidate data from various sources into a single platform, making it easier to manage and access. The computing system 150 can support large-scale data storage and processing, accommodating growing data volumes and increasing complexity. The computing system 150 can enable real-time data processing and analytics, allowing organizations to respond quickly to changing conditions. The computing system 150 can facilitate collaboration across different departments and teams by providing a unified data environment. The computing system 150 can implement data governance and quality control measures to ensure the accuracy and reliability of data. The computing system 150 can provide organizations with the tools and insights needed to make informed, data-driven decisions. In summary, the computing system 150 can provide the infrastructure and tools needed to manage, process, and analyze data effectively, enabling organizations to unlock the full potential of their data assets. The computing system 150 can also provide business intelligence and reporting. The computing system 150 can aggregate data from multiple sources to generate comprehensive reports and dashboards for business analysis. The computing system 150 can provide real-time analytics. In particular, the computing system 150 can monitor and analyze data streams in real-time to gain immediate insights and drive instant actions. The computing system 150 can provide customer insights by analyzing customer data to understand behavior patterns, preferences, and trends to improve customer experience and loyalty. The computing system 150 can implement predictive maintenance as well, such as using machine learning models to predict equipment failures, capacity deficiencies, and schedule proactive capacity solutions and/or maintenance.

FIG. 1B is a block diagram of the computing system 150 of FIG. 1A according to some embodiments. In at least some embodiments, the computing system 150 includes memory 142, a central processing unit (CPU) or other processor, a display device 162, a persistent storage device 164, and a network interface 168. The memory 142 (as well as the persistent storage device 164) can store capacity data 152 and instructions 154. The CPU 160 can include one or more processing devices in the case that the computing system 150 is distributed, while the memory 142 and the persistent storage devices 164 (among other components) may or may not be distributed, e.g., located across different locations of a network such as the cellular network 120 or within the cloud with which the cellular network 120 communicates.

For example, in embodiments, the computing system 150 is implemented in a cloud computing system, providing data storage, data warehousing, real-time data processing, analytic engines for large-scale data processing, ML/AI services, data flow for stream and batch processing, or other data services. As described in more detail below, the computing system 150 can provide and present a GUI 172 within the display device 162 in connection with a capacity planning tool. The capacity planning tool may be instantiated within the instructions 154, which when executed by the one or more processing devices of the CPU 160, presents the GUI 172 with a map and various menus and views associated with the map that will be discussed in more detail hereinafter. In some embodiments, the GUI 172 includes, in connection with the CPU 160, a framework capable of generating and/or modifying executable code (represented by graphical objects in the GUI) for utility programs, applications, functions, routines, scripts, processing pipelines, solutions, connector functions, object stores, enterprise integration tools, or other executable code associated with capacity planning.

As discussed, the capacity data 152 can be associated with bandwidth of various network components (taken alone or in the aggregate in some cases), throughput, and network traffic and associated demands for the bandwidth. The computing system 150 can aggregate and track such capacity data 152 for purposes of determining and updating capacity metrics at various layers of the cellular network 120 that informs whether particular network components have (or will have at some point in the future) capacity-related issues that are expected to result in breaks (e.g., dropped calls or dropped network sessions) and the like that result in negative QoS and QoE. In some embodiments, the capacity metrics are stored in the persistent storage device 164 and, as needed, in the memory 142 when being updated with newly received capacity data 152. In this way, capacity metrics associated with various network components can be updated over time and presented, through various means (such as text box, overlay graphics, and the like) to the GUI 172.

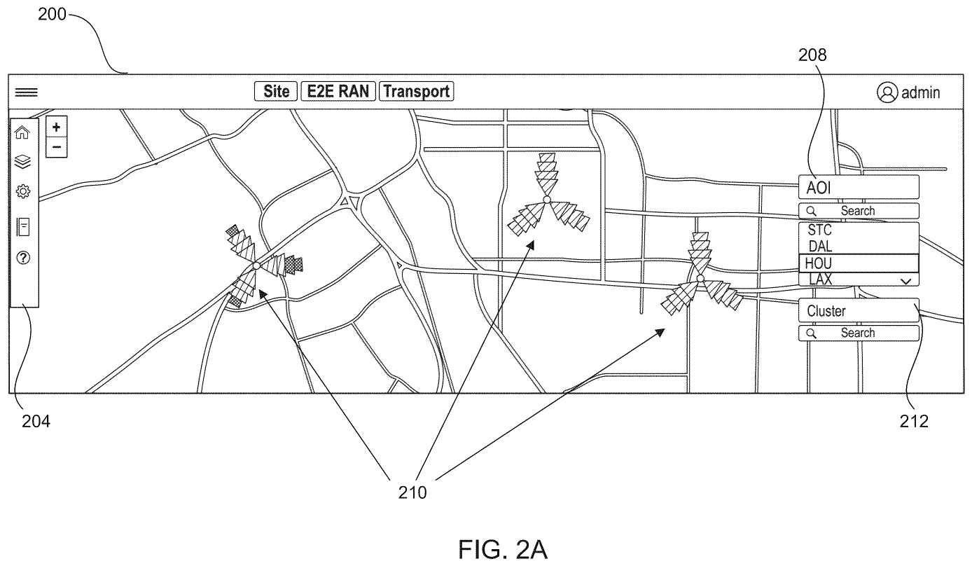

FIG. 2A, FIG. 2B, FIG. 2C, FIG. 2D illustrate a graphical user interface or GUI 200, including a map of an area of interest (AOI) of the cellular network 120, presentable on the display device 162 of the computing system 150 according to at least some embodiments. In some embodiments, the GUI 200 is the GUI 172 discussed with reference to FIG. 1B. The computing system 150 can present, in the GUI 200, a main menu 204, an AOI selector 208, and a cluster selector 212 (FIG. 2A) along with components of the cellular network 120, e.g., which can include a plurality of sites 210 of the cellular network 120.

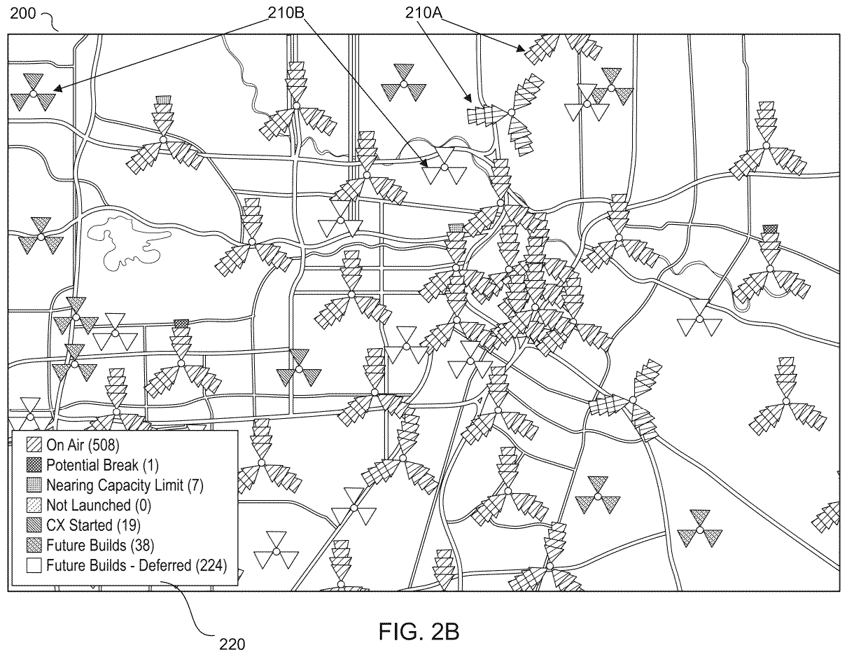

In embodiments, the main menu 204 enables selecting various functionalities or features of the capacity planning tool executed by the computing system 150, e.g., see FIG. 3. These functionalities and features will be discussed in detail as relevant to the present disclosure. For example, a user can select an export icon on the main menu 204 that enables exporting tabular data having selectable views and filters. The tabular data, for example can list component identifier (ID) and corresponding capacity metrics.

The AOI selector 208 may be a drop-down menu of selectable AOIs, which are pulled from a database or data store (e.g., of the persistent storage device 164), and which may be searchable within a separate text input box. As illustrated, the current user has selected Houston (HOU) as the AOI. In embodiments, the cluster selector 212 functions similar to the AOI selector 208, except that a cluster is a subset of the selected AOI and can therefore provide better granularity, e.g., by zooming into a dense cluster of sites within an urban environment for example.

The term “selection” will be referenced throughout this description making reference to use of a cursor or mouse pointer (or the like input/output (I/O) device) of the computing system 150 to select a link, icon, indicator, or other selectable option within the GUI 200. This selection can be performed differently in different embodiments, such as hoovering over or clicking on the option, whether a right click, a middle click, or a left click, as may be available. Different forms of selection may enable access to different types or groups of data or information, to include keyboard or touch screen selection options. Those skilled in the art will recognize other ways that options within a GUI 200 are selected by a user or operator through various I/O devices.

In at least some embodiments, in response to detecting selection of an AOI through the AOI selector, the computing system 150 retrieves (e.g., from the persistent storage device 164) geolocation data for the plurality of sites 210 of the cellular network 120 within the AOI. The computing system 150 can further present, within the GUI 200 over the map, graphical objects representing the plurality of sites 210, e.g., the components of those sites as will be discussed in detail. The graphical objects can include indicators for a plurality of cells of the plurality of sites, as discussed below with reference to FIG. 2B. A user can then zoom in and out to inspect, hover over, or click on the indicators associated with the plurality of sites to perform different functions that will be discussed.

As illustrated in FIG. 2B, the sites 210 can be classified as active sites 210A (e.g., on-air sites) or non-active sites 210B. In various embodiments, a legend 220 can identify what kinds of sites these are by particular shading and how many of each kind exist in the AOI, e.g., via a number in parentheses after the site type in the legend 220. For example, the non-active sites 210B can include sites that are not launched, in-construction, future-builds, or future-builds deferred. The not-launched sites may be construction but not yet active, the in-construction sites not yet fully built, the future-build sites may be allocated for construction, and the deferred sites have been identified but not prioritized (or ranked sufficiently) high to be allocated to be built.

FIG. 2C illustrates a plurality of indicators for any active site 210A presented in the GUI 200 following selection of a particulate AOI. In this example, the active site 210A can include three sectors 225, e.g., a first sector 225A, a second sector 225B, and a third sector 225C. Each sector can be orientated at approximately 120 degrees apart, or other equidistant value to minimize cross-cell interference between sectors, pointing in different directions, referred to as azimuths. Each sector can include multiple cell indicators 230, typically between two and six cell indicators per sector corresponding to the actual cells, which are configurable depending on traffic demand among other factors. As illustrated, the first sector 225A includes a first cell indicator 230A of a first cell, a second cell indicator 230B for a second cell, a third cell indicator 230C for a third cell, and a fourth cell indicator 230D for a fourth cell. Further, a frequency band deployed by each cell in a sector can be a different frequency band to increase overall capacity of the sector. In some embodiments, a separate cell indicator can be used for a different band if a cell is able to multiplex between bands, for example. In this way, the capacity data can be organized according to sector and cell of each site, the cells within each sector include between two and six different frequency bands.

FIG. 2D illustrates a non-active site 210B, which when selected (e.g., hoovered over or clicked) causes the computing system 150 to present, in the GUI 200, particular site information in a text box 211. This particular non-active site 210B is in construction and is illustrated only by way of example, as each site illustrated on the map, when selected, can present the same or different site information. In this example, the site information in the text box 211 includes a site identifier (ID), a launch category (e.g., build), a year 2024, a status, and other date information, including a projected on-air date.

With additional reference to FIG. 2B, the indicators of each site can be shaded to indicate a capacity status that can be derived from one or more capacity metrics for each respective site, where the indicators relate to cells and/or sectors of each site. For example, as illustrated in the legend 220, the status can include on-air (e.g., is active and functioning with normal capacity), involves a potential break, or is nearing a capacity limit. In embodiments, a potential break can be restated as at least one capacity metric of a plurality of capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

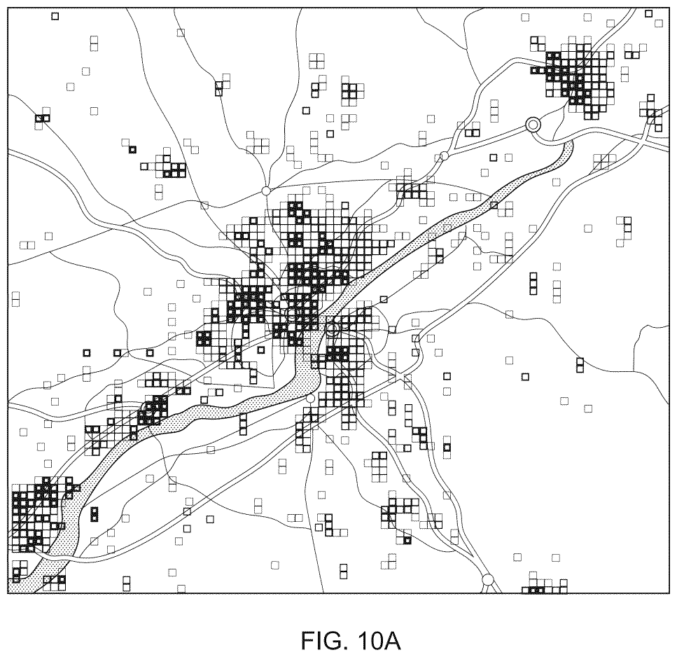

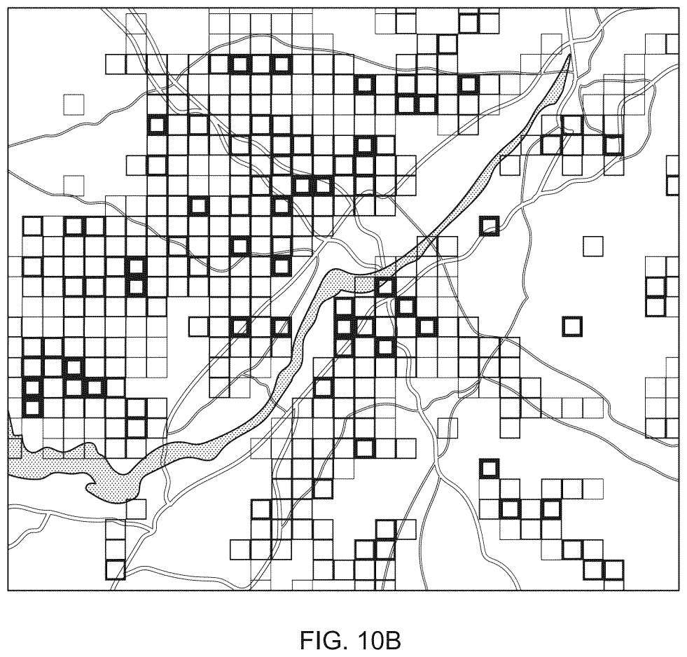

FIG. 3 is an image of a menu 300 presentable within the GUI 200 as an overlay to the map and that provides selection options of various capacity-related aspects of the cellular network according to some embodiments. For example, a multi-layer icon can be selected from the main menu 204, which causes the menu 300 to pop up over the map listing high-level menu options, such as “Network” (see FIG. 10B) and “Map.” In embodiments, selection of “Map” can cause a drop down of further options, such as map, population, traffic, points of interest, economic value, cellular stores, serving plot, and site ranking, not all of which will be discussed herein. When one of the “Map” options is selected, corresponding graphical indicators and information can be illustrated on the map so that such indicators and information is selectively displayed, to maintain simplicity of what is shown on the map. For example, if too many indicators or too much information is simultaneously displayed, the map would be too congested to meaningfully discern and use the displayed content.

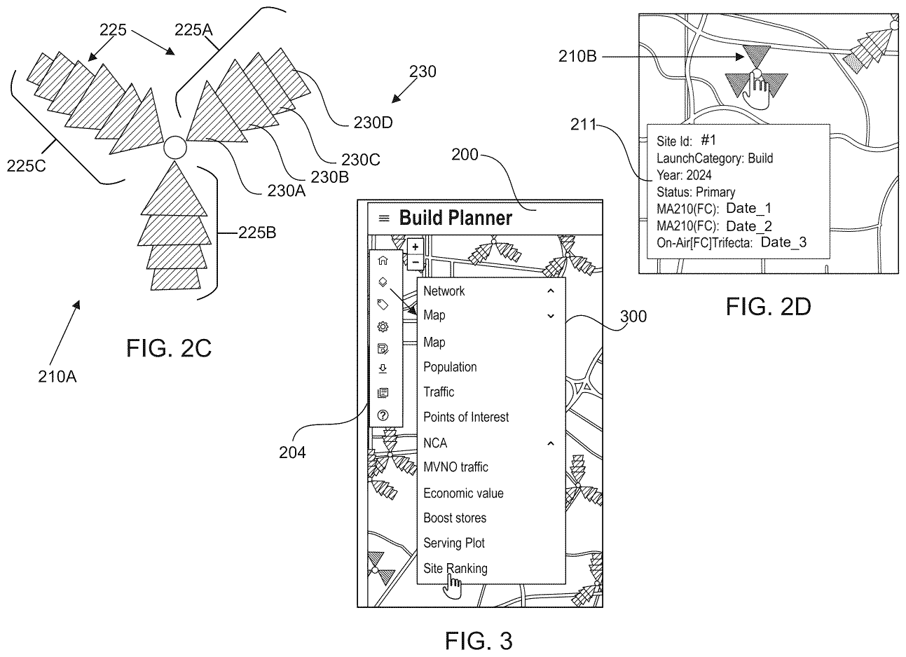

FIG. 4 is a screen capture of a GUI 400 in which a map is presented having illustrated a plurality of partitioned sections of the AOI according to exemplary embodiments. More specifically, the computing system 150 can (e.g., through execution of a software or program instructions associated with the capacity planning tool) identify a portion or a sub-area 402 of the current AOI (or more than one AOI) that has been selected. This identification can be through user indication of particular cities, longitude and latitude points corresponding to the sub-area 402, or by receiving selection actions of a cursor over the map that specifies the sub-area 402 to be analyzed. Once identified, the computing system 150 can identify an extreme corner of the sub-area from which to starting scanning. In the illustrated example, a longitude and latitude point 403 of the extreme left, bottom corner (or extreme southwest corner) of the sub-area 402 has been identified from which to start scanning.

In some embodiments, the computing system 150 then scans, starting from the starting point, across the sub-area 402 to identify the aforementioned plurality of sections. For example, the computing system 150 can contiguously scan pixels of the map from a first side 405A (e.g., the left side) to a second side 405B (e.g., the right side) while moving from the south to the north of the at sub-area 402 of the AOI (see squiggly dark line). In embodiments, in scanning pixels, the second side 405B is a farthest distance away from the first side 405A. This scanning of pixels can identify a plurality of rows 410A of pixels of a particular height, depending on a desired size of each section. For example, the computing system 150 can identify, from each of the plurality of rows while scanning, a subset of sections within each respective row of each respective scan. A natural result of identifying sections along each row of the plurality of rows 410A is to also partition the AOI into a plurality of columns 410B, e.g., such that a resultant grid defines the plurality of sections. Each section can be of a particular length and width (or square in some embodiments), and thus a particular number of sections can fit within each row of a known length, wherein the rows can vary in length, as illustrated, depending on geography and the contours of the sub-area 402.

In at least some embodiments, the computing system 150 assigns a section identifier (or section ID) to each identified section in the AOI, e.g., which may also be referred to as a partitioned section herein. In some embodiments, the computing system 150 assigns a different series of section IDs to different AOIs and thus can keep AOIs distinguished if the sub-area 402 spans across more than one AOI. In this way, capacity data 152 associated with each section and AOI can be labeled or tagged with its corresponding section ID so that the processing performed in relation to each section and AOI can be tracked back to the corresponding section having a particular length and width in longitude and latitude positioning on the map of a particular AOI. Ultimately this allows capacity metric volume to be correlated to each partitioned section and AOI, as will be discussed.

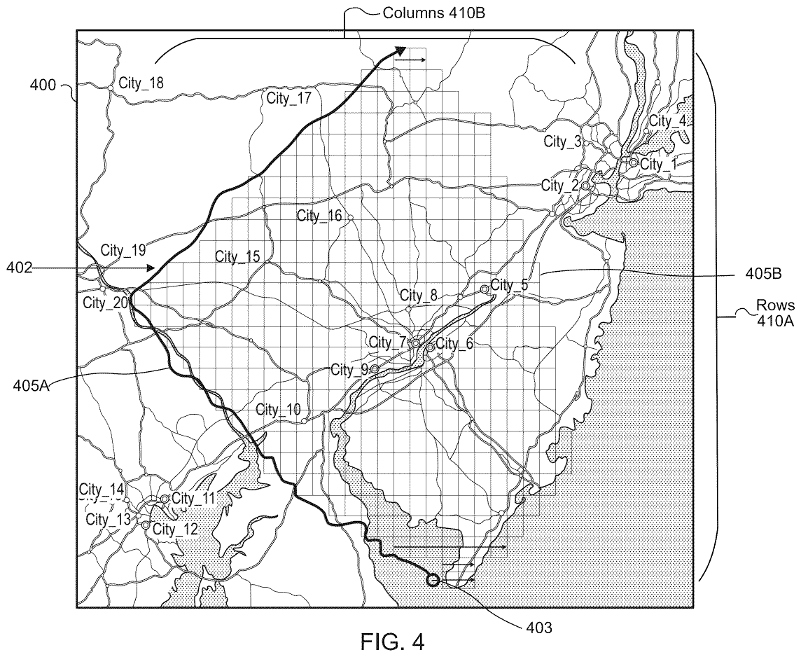

FIG. 5 is a an image of a representative group of sections of the plurality of partitioned sections of FIG. 4, illustrating an example of determining a traffic metric volume for individual sections according to some embodiments. For example, the group of sections can include sections 502A through 502I as part of the plurality of sections, illustrated here only by way of example. Further by way of example, information for each section can be tracked, e.g., in the memory 142 of the computing system 150, which can include the section ID, a centroid longitude and latitude location of the section, a number of total geolocation samples (e.g., each geolocation sample corresponding to a different subscriber device or UE), the number of geolocation samples coming from each cell that has coverage within the section, and a total metric value (e.g., illustrated in a first section 502A of the plurality of sections as 400 gigabytes (GB) of traffic volume). Although only Cells A, B, C, and X are illustrated as contributing to the geolocation samples, it should be understood that additional cells could be contributing to the total capacity metric value, and that these cells are illustrated for simplicity of illustration and explanation.

In embodiments, using the first section 502A as exemplary for Cell A, the computing system 153 divides the total number of geolocation samples for Cell A by the total number of samples, e.g., which could be 100 geolocation samples for Cell A divided by a 1,000 total number of geolocation samples for the first section 502A, which results in 0.10 (or 10 percent). This percentage value (0.10) can then be multiplied by the capacity metric volume from Cell A, which is a known value from the capacity data 152. So, if the capacity metric volume for Cell A is 500 GB (e.g., traffic volume), then the capacity metric volume attributed to Cell A in the first section 502A is 50 GB. This can be repeated for each cell to determine a total capacity metric volume for the first section 502A, which by way of example is 400 GB. In this way, a heat map can be created illustrating volume ranges of capacity metric volume for different sections, as will be illustrated with reference to FIGS. 10A-10B.

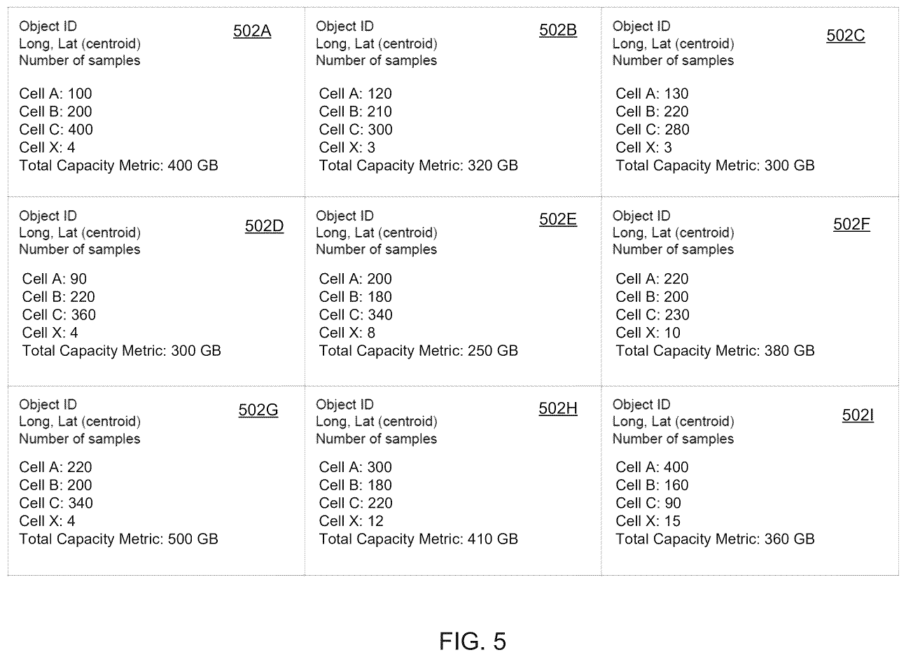

FIG. 6 is an image of a representative group of sections of the plurality of sections of FIG. 4, illustrating how known samples of geolocations of subscriber devices (or UEs) are distributed based on sector and cell according to some embodiments. In embodiments, the active site 210A referred to with reference to FIG. 2C is illustrated on the map across a plurality of sections that have been partitioned as was discussed with reference to FIG. 4. Here, a plurality of geolocation samples of different subscriber devices are illustrated that correspond to three different cells, which again, are only exemplary by way of example. Each of Cell A, Cell B, and Cell C share in providing these geolocation samples, where the first sector 225A of the active site 210A contributes the geolocation samples of Cell C, which are numerous and closest to the active site 210A. Thus, the geolocation samples coming from Cell A and Cell B are less numerous, where Cell A and Cell B are associated with a sector of one or more different active sites that are not illustrated for simplicity.

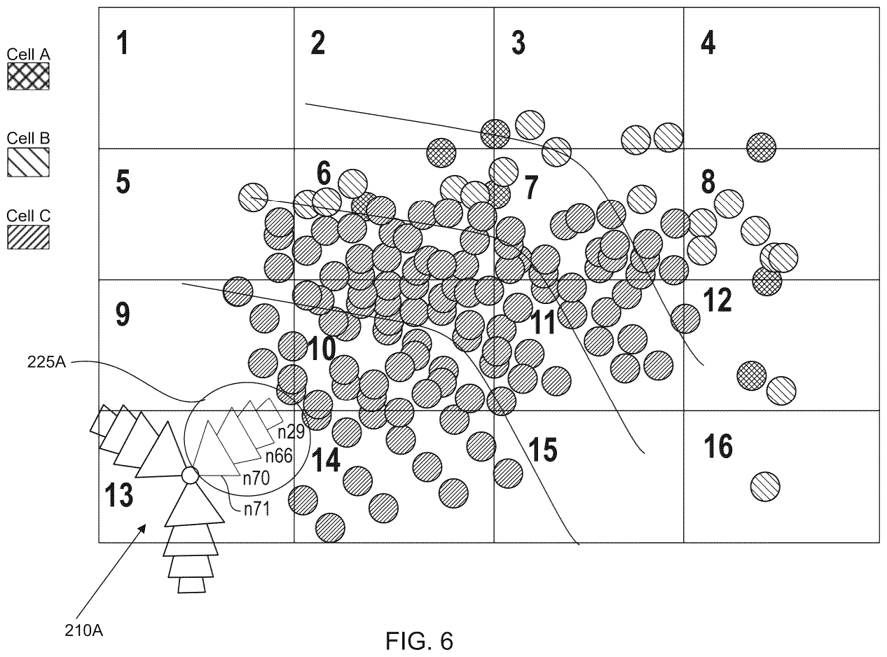

In varying embodiments, the map can contain geolocation samples for each cell and sector in the sub-area 402 and each sector will have associated capacity metric values such as for traffic volume, RRC connections, and/or unserved demand bandwidth. In this way, when the computing system 150 knows the traffic volume for a given sector during a given day, this traffic volume can be distributed among the plurality of sections based on the percentage number of geolocation samples located within each respective section. How this data is employed to determine the capacity metric volume of each section is discussed with reference to FIGS. 7-9.

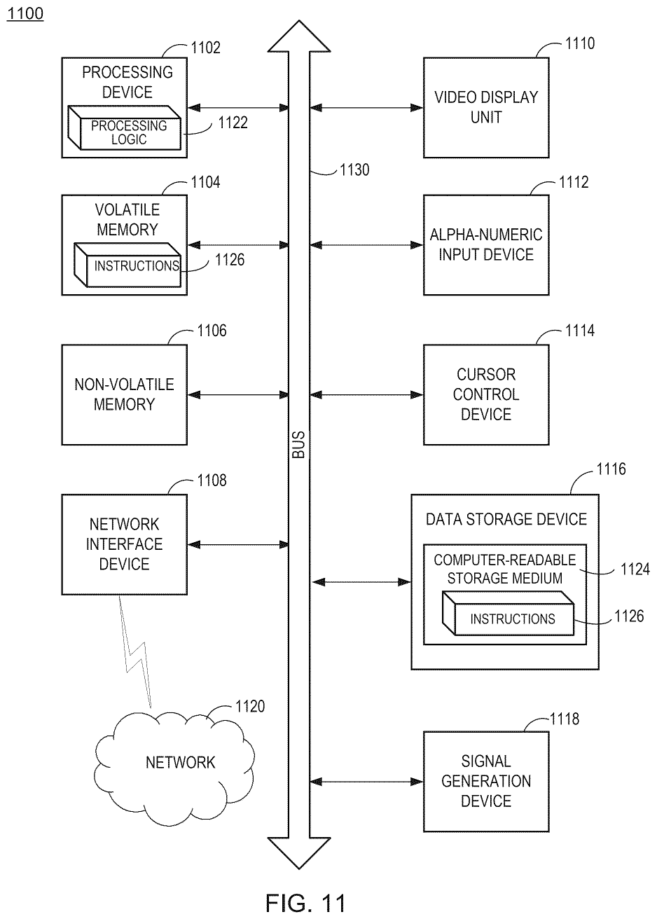

FIG. 7 is a flow chart of a method 700 for determining a capacity metric volume for each section based on a plurality of known geolocations and capacity metric volume of each cell according to some embodiments. The method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700 is performed by the computing system 150 of FIGS. 1A-1B with the GUI of the foregoing Figures. The method 700 can also be performed by other computing systems described herein, such as in FIG. 11. The operations of the method 700 can be performed in an order other than that specifically illustrated.

At operation 710, the processing logic presents, within the display device 162, a graphical user interface (GUI) including a map of an AOI of the cellular network.

At operation 720, the processing logic partitions at least a sub-area of the AOI into a plurality sections. In embodiments, each section is formed from a particular pixel area of the GUI, e.g., of a particular length and width of number of pixels.

At operation 730, the processing logic retrieves a plurality of geolocations, within each section of the plurality of sections, of subscriber devices based on known geolocations, e.g., where these geolocations correspond to the aforementioned geolocation samples. In embodiments, these geolocations are retrieved from the memory 142 of the computing system 150, e.g., from the capacity data 152.

At operation 740, the processing logic determines, using call record detail (CDR) data, a capacity metric volume for each sector of a plurality of sites covering the AOI (or that may span more than one AOI).

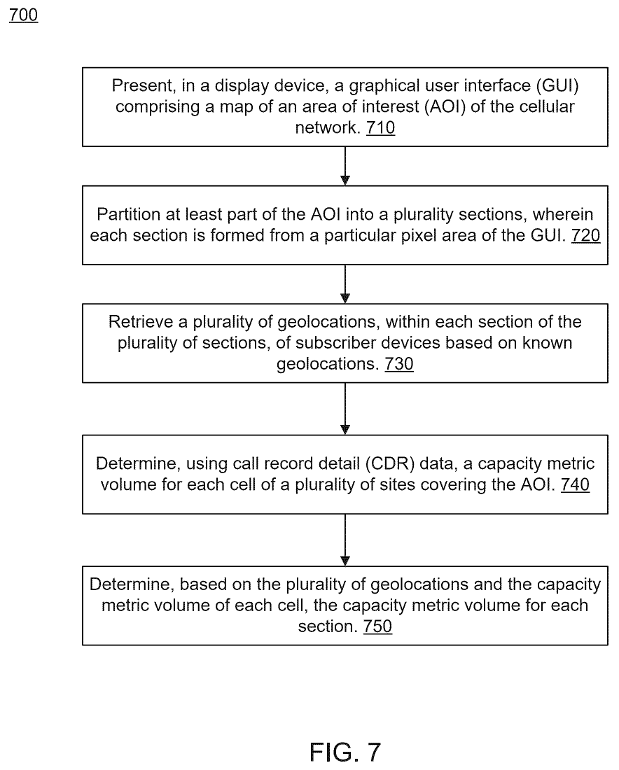

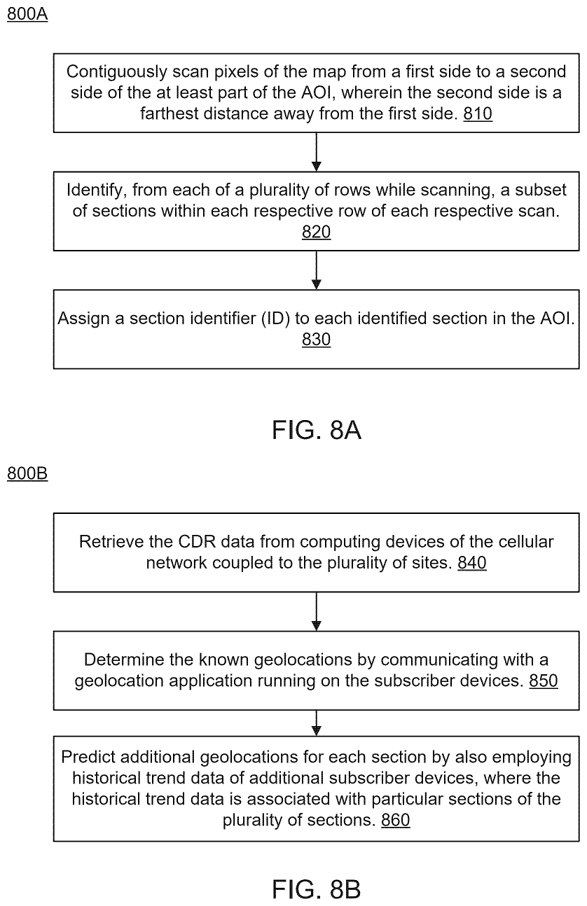

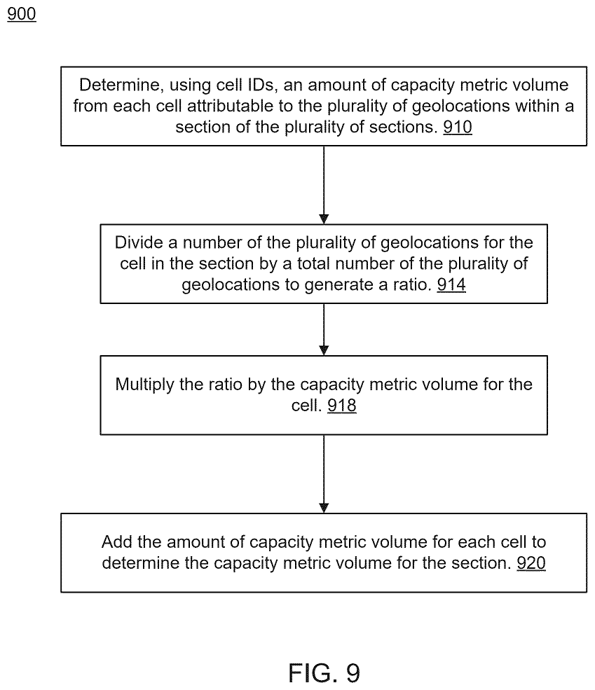

At operation 750, the processing logic determines, based on the plurality of geolocations and the capacity metric volume of each sector, the capacity metric volume for each section. Implementation of these operations will be discussed in more detail with reference to FIG. 8A, FIG. 8B, and FIG. 9.

FIG. 8A is a flow chart of an example method 800A for partitioning the AOI according to at least one embodiment. The method 800A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 800A is performed by the computing system 150 of FIGS. 1A-1B with the GUI of the foregoing Figures. The method 800A can also be performed by other computing systems described herein, such as in FIG. 11. The operations of the method 800A can be performed in an order other than that specifically illustrated.

At operation 810, the processing logic contiguously scans pixels of the map from a first side to a second side of the sub-area 402 of the AOI (see FIG. 4). In embodiments, the second side is a farthest distance away from the first side.

At operation 820, the processing logic identifies, from each of a plurality of rows while scanning, a subset of sections within each respective row of each respective scan.

At operation 830, the processing logic assigns a section ID to each identified section in the AOI, e.g., to use for tracking a capacity metric volume for each section ID and AOI.

FIG. 8B is a flow chart of an example method 800B for predicting additional geolocations within each section based on CDR data according to some embodiments. The method 800B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 800B is performed by the computing system 150 of FIGS. 1A-1B with the GUI of the foregoing Figures. The method 800B can also be performed by other computing systems described herein, such as in FIG. 11. The operations of the method 700 can be performed in an order other than that specifically illustrated.

At operation 840, the processing logic retrieves the CDR data from computing devices, of the cellular network, that are coupled to the plurality of sites, e.g., that communicate through the plurality of sites.

At operation 850, the processing logic determines the known geolocations by communicating with a geolocation application running on the subscriber devices.

At operation 860, the processing logic predicts additional geolocations for each section by also employing historical trend data of additional subscriber devices. In some embodiments, the historical trend data is associated with particular sections of the plurality of sections. This historical trend data can be associated with, for example, higher traffic areas (such as a shopping mall, higher income areas, etc.) where a growth in subscriber devices (e.g., UEs) is anticipated. Further, if geolocations are known through an application running on one type of smart phone (or UE), similar trends can be expected on another type of smart phone (or UE) having a similar saturation within a typical population. More specific projections of subscriber growth can be predicted with more specific historical trend data that is geo-specific.

FIG. 9 is a flow chart of an example method 900 of determining capacity metric volume from each cell in order to determine a capacity metric volume for each section according to some embodiments. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 900 is performed by the computing system 150 of FIGS. 1A-1B with the GUI of the foregoing Figures. The method 800B can also be performed by other computing systems described herein, such as in FIG. 11. The operations of the method 900 can be performed in an order other than that specifically illustrated. In some embodiments, FIG. 5 can also be referenced to help understand FIG. 9.

At operation 910, the processing logic determines, using cell IDs associated with the sectors, an amount of capacity metric volume from each cell attributable to the plurality of geolocations within a section of the plurality of sections.

To make the determination of operation 910 for each section, the processing logic can, at operation 914, divide a number of the plurality of geolocations for the sector in the section by a total number of the plurality of geolocations in the section to generate a ratio. At operation 918, the processing logic also multiplies the ratio by the capacity metric volume for the cell. The operations 910, 914, and 918 can also be performed at a sector level instead of cell level.

At operation 920, the processing logic adds the amount of capacity metric volume for each sector to determine the capacity metric volume for the section.

FIG. 10A is a screen capture of the map in which different sections are shaded differently based on a particular volume range of a capacity metric in each respective section according to an exemplary embodiment. FIG. 10B is a zoomed-in area of some of the different sections of the map of FIG. 10A to illustrate the shading with more clarity according to some embodiments. In some embodiments, the computing system 150 can further determine, for each section (see FIGS. 4-6), the capacity metric volume for a particular section is located within a particular volume range. The computing system 150 can then shade each section of the plurality of sections based on the particular volume range determined for each respective section.

As illustrated in FIGS. 10A-10B, the shading for highest values of the capacity metric volume (e.g., for traffic volume, number of RRC connections, or unserved demand) is a darker border for a section while, for lowest values, is a lighter border for that section, with variable levels of darkness/lightness in between. A different capacity metric type can be illustrated at a time via a selection of a pop-up screen of the main menu 204 (FIG. 3). The levels of shading can be adjusted based on the capacity metric volume for each section falling with a range associated with a particular shading degree. In other embodiments, each entire section can be shaded with different gradations of darkness or lightness instead of just the border.

FIG. 11 illustrates a block diagram illustrating an exemplary computer device 1100 (or computing device), in accordance with implementations of the present disclosure. Computer device 1100 can correspond to the computing system 150 (or device), as described above. Example computer device 1100 can be connected to other computer devices in a LAN, an intranet, an extranet, and/or the Internet. Computer device 1100 can operate in the capacity of a server in a client-server network environment. Computer device 1100 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 1100 can include a processing device 1102 (also referred to as a processor, CPU, or GPU), a volatile memory 1104 (or main memory, e.g., read-only memory (ROM), flash memory, dynamic random access memory (DRAM) such as synchronous DRAM (SDRAM), etc.), a non-volatile memory 1106 (e.g., flash memory, static random access memory (SRAM), etc.), and a secondary memory (e.g., a data storage device 1116), which can communicate with each other via a bus 1130.

Processing device 1102 (which can include processing logic 1122) represents one or more general-purpose processing devices such as a microprocessor, central processing unit, or the like. More particularly, processing device 1102 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1102 can also be one or more special-purpose processing devices such as an ASIC, a FPGA, a digital signal processor (DSP), network processor, or the like. In accordance with one or more aspects of the present disclosure, processing device 1102 can be configured to execute instructions performing the method disclosed herein.

Example computer device 1100 can further comprise a network interface device 1108, which can be communicatively coupled to a network 1120. Example computer device 1100 can further comprise a video display 1110 (e.g., a LCD (liquid crystal display) or organic light-emitting diode (OLED) monitor, a virtual-reality (VR) or augmented-reality (AR) display, a touch screen, or a cathode ray tube (CRT)), an alphanumeric input device 1112 (e.g., a keyboard), a cursor control device 1114 (e.g., a mouse, track ball, or touch pad), and an acoustic signal generation device 1118 (e.g., a speaker). Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Data storage device 1116 can include a computer-readable storage medium 1124 (or, more specifically, a non-transitory computer-readable storage medium) on which is stored one or more sets of executable instructions 1126 (e.g., processor-readable instructions). In accordance with one or more aspects of the present disclosure, executable instructions 1126 can comprise executable instructions performing the method disclosed herein.

Executable instructions 1126 can also reside, completely or at least partially, within volatile memory 1104 and/or within processing device 1102 during execution thereof by example computer device 1100, volatile memory 1104 and processing device 1102 also constituting computer-readable storage media. Executable instructions 1126 can further be transmitted or received over a network via network interface device 1108.

While the computer-readable storage medium 1124 is shown in FIG. 11 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
presenting, in a display device, a graphical user interface (GUI) comprising a map of an area of interest (AOI) of the cellular network;
partitioning at least a sub-area of the AOI into a plurality sections, wherein each section is formed from a particular pixel area of the GUI;
retrieving a plurality of geolocations, within each section of the plurality of sections, of subscriber devices based on known geolocations;
determining, using call record detail (CDR) data, a capacity metric volume for each cell of a plurality of sites covering the AOI; and
determining, based on the plurality of geolocations and the capacity metric volume of each cell, the capacity metric volume for each section.

2. The computing system of claim 1, wherein the operations further comprise:
retrieving the CDR data from computing devices, of the cellular network, that are coupled to the plurality of sites;
determining the known geolocations by communicating with a geolocation application running on the subscriber devices; and
predicting additional geolocations for each section by also employing historical trend data of additional subscriber devices, wherein the historical trend data is associated with particular sections of the plurality of sections.

3. The computing system of claim 1, wherein the partitioning comprises:
contiguously scanning pixels of the map from a first side to a second side of the sub-area of the AOI, wherein the second side is a farthest distance away from the first side;
identifying, from each of a plurality of rows while scanning, a subset of sections within each respective row of each respective scan; and
assigning a section identifier (ID) to each identified section in the AOI.

4. The computing system of claim 1, wherein the operations further comprise:
determining, using cell IDs, an amount of capacity metric volume from each cell attributable to the plurality of geolocations within a section of the plurality of sections; and
adding the amount of capacity metric volume for each cell to determine the capacity metric volume for the section.

5. The computing system of claim 4, wherein, to determine the amount of capacity metric volume from each cell for the section, the operations further comprise:
dividing a number of the plurality of geolocations for the cell in the section by a total number of the plurality of geolocations to generate a ratio; and
multiplying the ratio by the capacity metric volume for the cell.

6. The computing system of claim 1, wherein the operations further comprise:
determining, for each section, the capacity metric volume for the section is located within a particular volume range; and
shading each section of the plurality of sections based on the particular volume range determined for each respective section.

7. The computing system of claim 1, wherein the capacity metric volume corresponds to a capacity metric comprising one of radio resource control (RRC) connections, traffic volume, and unserved demand bandwidth.

8. A method to facilitate a cellular network, the method comprising:
presenting, within a display device of a computing system, a graphical user interface (GUI) comprising a map of an area of interest (AOI) of the cellular network;
partitioning at least a sub-area of the AOI into a plurality sections, wherein each section is formed from a particular pixel area of the GUI;
retrieving a plurality of geolocations, within each section of the plurality of sections, of subscriber devices based on known geolocations;
determining, using call record detail (CDR) data, a capacity metric volume for each sector of a plurality of sites covering the AOI; and
determining, by the computing system, based on the plurality of geolocations and the capacity metric volume of each sector, the capacity metric volume for each section.

9. The method of claim 8, further comprising
retrieving the CDR data from computing devices, of the cellular network, that are coupled to the plurality of sites;
determining the known geolocations by communicating with a geolocation application running on the subscriber devices; and
predicting additional geolocations for each section by also employing historical trend data of additional subscriber devices, wherein the historical trend data is associated with particular sections of the plurality of sections.

10. The method of claim 8, wherein the partitioning comprises:
contiguously scanning pixels of the map from a first side to a second side of the sub-area of the AOI, wherein the second side is a farthest distance away from the first side;
identifying, from each of a plurality of rows while scanning, a subset of sections within each respective row of each respective scan; and
assigning a section identifier (ID) to each identified section in the AOI.

11. The method of claim 8, further comprising:
determining, using cell IDs associated with the sectors, an amount of capacity metric volume from each sector attributable to the plurality of geolocations within a section of the plurality of sections; and
adding the amount of capacity metric volume for each sector to determine the capacity metric volume for the section.

12. The method of claim 11, wherein, to determine the amount of capacity metric volume from each sector for the section, the method further comprising:
dividing a number of the plurality of geolocations for the sector in the section by a total number of the plurality of geolocations to generate a ratio; and
multiplying the ratio by the capacity metric volume for the sector.

13. The method of claim 8, further comprising:
determining, for each section, the capacity metric volume for the section is located within a particular volume range; and
shading each section of the plurality of sections based on the particular volume range determined for each respective section.

14. The method of claim 8, wherein the capacity metric volume corresponds to a capacity metric comprising one of radio resource control (RRC) connections, traffic volume, and unserved demand bandwidth.

15. A non-transitory computer-readable storage medium, the computer-readable storage medium including instructions that when executed by a computing system, cause the computing system to perform operations comprising:
presenting, within a display device of the computing system, a graphical user interface (GUI) comprising a map of an area of interest (AOI) of a cellular network;
partitioning at least a sub-area of the AOI into a plurality sections, wherein each section is formed from a particular pixel area of the GUI;
retrieving a plurality of geolocations, within each section of the plurality of sections, of subscriber devices based on known geolocations;
determining, using call record detail (CDR) data, a capacity metric volume for each cell of a plurality of sites covering the AOI; and
determining, by the computing system, based on the plurality of geolocations and the capacity metric volume of each cell, the capacity metric volume for each section.

16. The non-transitory computer-readable storage medium of claim 15, wherein the operations further comprise:
retrieving the CDR data from computing devices, of the cellular network, that are coupled to the plurality of sites;
determining the known geolocations by communicating with a geolocation application running on the subscriber devices; and
predicting additional geolocations for each section by also employing historical trend data of additional subscriber devices, wherein the historical trend data is associated with particular sections of the plurality of sections.

17. The non-transitory computer-readable storage medium of claim 15, wherein the partitioning comprises:
contiguously scanning pixels of the map from a first side to a second side of the sub-area of the AOI, wherein the second side is a farthest distance away from the first side;
identifying, from each of a plurality of rows while scanning, a subset of sections within each respective row of each respective scan; and
assigning a section identifier (ID) to each identified section in the AOI.

18. The non-transitory computer-readable storage medium of claim 15, wherein the operations further comprise:
determining, using cell IDs, an amount of capacity metric volume from each cell attributable to the plurality of geolocations within a section of the plurality of sections; and
adding the amount of capacity metric volume for each cell to determine the capacity metric volume for the section.

19. The non-transitory computer-readable storage medium of claim 18, wherein, to determine the amount of capacity metric volume from each cell for the section, the operations further comprise:
dividing a number of the plurality of geolocations for the cell in the section by a total number of the plurality of geolocations to generate a ratio; and
multiplying the ratio by the capacity metric volume for the cell.

20. The non-transitory computer-readable storage medium of claim 15, wherein the operations further comprise:
determining, for each section, the capacity metric volume for the section is located within a particular volume range; and
shading each section of the plurality of sections based on the particular volume range determined for each respective section.
